(19) United States
(12) Patent Application Publication
(10) Pub. No.: US 2014/0150080 A1
(43) Pub. Date: May 29, 2014

(54) AUTHORIZING ACCESS TO DIGITAL CONTENT

(71) Applicants: Benjamin Miller, Bedfordshire (GB); Mark Stubbs, Bedfordshire (GB)

(72) Inventors: Benjamin Miller, Bedfordshire (GB); Mark Stubbs, Bedfordshire (GB)

(73) Assignee: PIXELMAGS INC., Los Angeles, CA (US)

(21) Appl. No.: 13/825,963

(22) PCT Filed: Sep. 26, 2011
(86) PCT No.: PCT/US11/53309

§ 371 Date: Aug. 9, 2013

(30) Foreign Application Priority Data
Sep. 24, 2010 (GB) 1016084.4

(51) Int. Cl. H04L 29/06

(52) U.S. Cl. CPC H04L 63/08
USPC 726/9

(57) ABSTRACT

Systems and methods for controlling access to content are disclosed. Content can be consumed by a device. Access to the content is controlled by duration. A device is provided with a token that allows the user to consume content via a subscription basis.

### CROSS REFERENCE TO RELATED APPLICATIONS

This application claims the benefit of and priority to United Kingdom Application No. 1016084.4, filed Sep. 24, 2010 which is incorporated herein by reference in its entirety.

### BACKGROUND

2. The Field of the Invention

Embodiments of the invention relate generally to systems and methods for accessing content. More specifically, embodiments relate to systems and methods for controlling access to content by subscription.

2. The Relevant Technology

The Internet has become an integral part of everyday life. For example, people shop, perform research, listen to music, browse websites, and interact socially on the Internet. Although the Internet affords many advantages, it also poses significant challenges to many entities. Conventional businesses, for example, need to adapt their business to the Internet in order to compete. As people and businesses adapt to the Internet, there are many areas that are having difficulty in monetizing the Internet.

For example, the music industry has experienced some of these issues. At one time, music was distributed with Digital Rights Management (DRM) built into the files in an attempt to control distribution of the content. This proved unsuccessful and was abandoned for the most part. The newspaper industry is experiencing similar problems. By making their content available online, they are experiencing a drop in subscribing customers. The ability to present their content using the advantages afforded by the Internet has, at the same time, created problems in their business.

There is a need for systems and methods that can take advantage of the Internet while still enabling businesses to monetize their content successfully.

### SUMMARY

Embodiments of the invention relate to systems and methods for controlling access to content. Authorizing access to content is an example of controlling access to content. In one example, controlling access to content includes receiving usage data from a device. The usage data may include a token that includes parameters related to how a user or device may access content. A determination is then made from the token whether the device is entitled to access the content or a portion of the content. The token may also be updated or replaced when the device is entitled to access the content. When the token is valid, access to the content is enabled.

In another example, a method for controlling access to content includes receiving a request to access a resource included in content. The content may be provided by multiple publishers and a resource may be a specific instance or portion of the content. A token assigned to the user is retrieved from memory of a device and a determination is made as to the validity of the token. Access to the requested resources allowed when the token is valid.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE FIGURES

In order to describe the manner in which at least some of the advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram of an illustrative environment for controlling access to content;

FIG. 2 is an illustrative of a user interface on a device configured to access content;

FIG. 3 is an illustrative flow diagram of a method for accessing content;

FIG. 4 is an illustrative flow diagram of a method for accessing content; and

FIG. 5 illustrates an example of a method for authorizing access to digital content.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Embodiments of the invention relate generally to systems and methods for controlling access to content. Embodiments allow users to consume content of various forms. Access to the content can be controlled according to a subscription that may be implemented with multiple levels. Some levels may control access on a timed basis and access is restricted on a timed basis. For instance, access to the content can be restricted by the duration in which a user consumes the content. Access is not necessarily limited to specific content and is not restricted by the content itself. Other subscription levels may provide access that is restricted according to the status of the user's device (e.g., online or offline). The access may be unlimited online access. Alternatively, the access may be unlimited while both online and offline. In one example, the content may not be protected by digital rights management. A user may have unlimited offline access one a specific device, but be unable to share the content with another device.

Examples of content include, but are not limited to, images, text or other readable content, video, html content, or other content accessible over a network or the like or any combination thereof. In one example, the content may include digital copies of magazines, newspapers, or other readable/viewable content, which may also include images, videos, and/or links to other content.

In one embodiment, fees generated from providing or controlling access to the content can be distributed with the publishers of the content. At least some of the fees generated from the user's consumption of content may be distributed to publishers of the content actually viewed or consumed by the user. In this manner, a wide variety of content can be made available to users and each publisher can monetize their specific content.

As a user consumes content, the interaction of the user with the content is recorded. A device (or client operating on the device) may track which content (or which specific resource) is consumed (e.g., viewed, downloaded, read, heard), how long the content is consumed, status of the device (online or offline), or the like. The consumption of content can be tracked while the device is online and/or while the device is offline. This information is provided to a content server that maintains the usage data and uses the usage data when controlling access to the content. The usage data may also be used to compensate publishers for the consumption of their content.

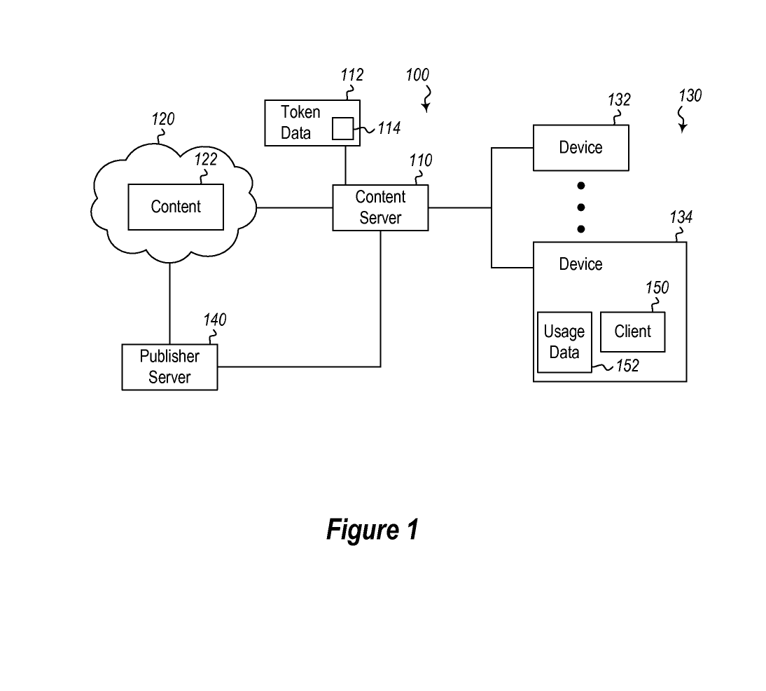

FIG. 1 illustrates a block diagram an illustrative environment for controlling access to content. The communications occurring between devices and servers in FIG. 1 may occur over a wireless and/or wired network. FIG. 1 illustrates a content server 110, a publisher server 140, and devices 130. The content server 110 cooperates with the publisher server 140 to provide the devices 130 with access to content 122.

The content server 110 controls access to the content 122. Controlling access to the content 122 can include various responsibilities that include token generation, usage data updating, or the like. In one example, embodiments of the invention enable access to the content 122. Controlling the access to the content 122 can be accomplished using tokens that can be verified and generated by the content server 110 without having to connect to a central database or maintain any state. The token may include various parameters that can define how the content can be accessed by the user. The tokens are delivered to the devices 130 as appropriate (each device may receive its own token). Clients operating of the devices 130 can then verify the tokens. Once the tokens are verified or validated, access to the content 122 may be enabled.

In FIG. 1, the content 122 may be stored in a storage device in a network 120. The network 120 may be accessible to the content server 110 and/or the publisher server 140 and may be the Internet. The content 122 may be stored at a secure location accessible to the content server 110 and/or the publisher server 140. The publisher server 140 (which is representative of multiple publisher servers associated with multiple publishers) can provide resources, which are instances of the content 122, to be included in the content 122. A publisher of a first magazine, for example, can post a digital version of the first magazine to the content 122 as a resource. A second publisher of a second magazine can post a digital version of the second magazine to the content 122 as another resource. More generally, a resource may be an instance of digital content such as a digital edition of a magazine, a website or webpage, an instance of a video or the like or any combination thereof.

In some embodiments, each publisher may have the ability to control access to the posted or published content. For example, a publisher may limit the time that resources are included in the content 122.

The content server 110 may have the ability to access the content 122 and control the distribution of the content to the devices 130. For example, the content server 110 may have the ability to organize the content 122, encrypt the content 122, manage access to the content 122, search the content 112, generate tokens for multiple devices that are used in consuming the content, or the like. When the content 122 is received from the publisher server 140, the content server 110 may index the content or the like or otherwise prepare the content 122 for distribution. The content server 110 may prepare the content 122 such that it can be browsed, searched, or the like.

The content server 110 interacts, for example over a network such as the Internet, with the devices 130 to allow access to the content 122 and to distribute the content 122 to the devices 130. Access to the content 122 can be controlled using tokens 114. The tokens can be securely delivered to the devices and stored in a token database 112. Each of the devices 130 receives a token. The tokens 114 may include an expiration date of the token 114 and rights information that relates to how the content 122 can be consumed by a device or user of the device.

The devices 130 include a device 132 and a device 134 that are representative of various devices. Exemplary devices include, but are not limited to, smartphones and other cellular devices, tablet devices, laptop computers, e-readers, computers including desktop computers, other network enabled devices, or the like or any combination thereof. One or more of the devices 130 may be associated with the same user. Each of the devices, however, may have its own token. More than one token can also be associated with the same user or the same access plan or subscription.

In one example, a client 150 is installed on the device 134. The client 150 may be downloaded from the content server 110, for example. In another example, the client 150 may be a browser and embodiments of the invention may be implemented in a browser environment. Additional plug-ins or components are downloaded as necessary. The client 150 can maintain information that is used in controlling access to the content 122. The client 150 may also verify or validate the token prior to enabling access to the content 122.

When accessing the content 122, the device 134 (or the client 150) may communicate with the content server 110 over a network. If the device 134 is authorized or authenticated (for example when the device's token is verified or validated), the device 134 is allowed access to the content 122. If the device 134 is not authorized or if the token cannot be verified, the device 134 may be given the opportunity to enroll or subscribe in an appropriate plan in order to enable access to the content 122.

The client 150 maintains usage data 152 that describes how the content 122 or how specific resources of the content 122 are consumed. The usage data 152 includes, by way of example only and not limitation, the specific content viewed or consumed, the amount of time spent viewing the content or the amount of time viewing different content, the token at the time the content is consumed, the time when the content was consumed or viewed, status of the device 134 (e.g., online or offline), or the like or any combination thereof. The usage data 152 may be transmitted to the content server 110 on a regular basis or according to another schedule. For instance, the usage data 152 may be transmitted when the client 150 is started, when the client 150 terminates, during use of the client, or the like or any combination thereof.

In one example, a user may access a specific resource, such as a magazine. The time spent consuming the resource is tracked and included in the usage data. In some example, the usage data may be adjusted based on user input. If no input is received for some period of time (e.g., no page turn, no screen touches, or the like), then a timer may stop or time out. In this manner, the usage data may be managed in order to reflect actual consumption with certain allowances to account for user action or user inaction.

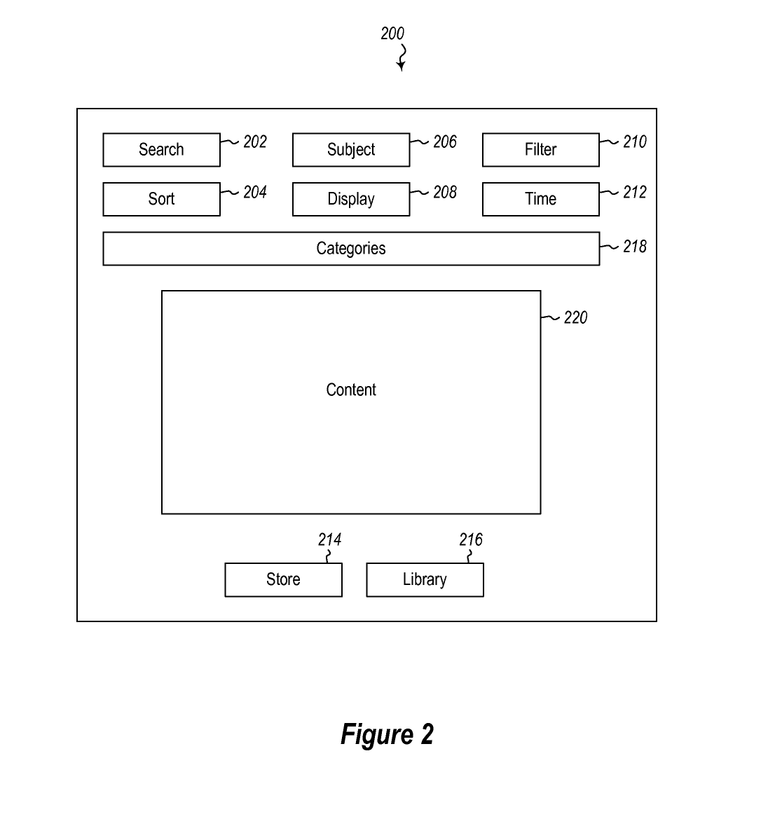

FIG. 2 illustrates an example of a user interface 200 that may be presented by the client 150 on a screen or display of the device 134. The user interface 200 may include one or more buttons, menus, or other tools that enable a user to browse the content 122 or otherwise navigate. The navigation of the content 122 can occur with respect to content that is remotely located over the Internet or with respect to content that has been downloaded to memory of the device 134. Once the device 134 has access to the content 122, content 220 may be displayed on the device 134. Initially, the content 220 may include images of content that can be browsed. Multiple images of different magazines or resources may be presented, for example. A user can then select one of the images to access the corresponding content of that particular magazine or other selected content.

The user interface 200 may include a search module 202. A user can enter search terms to search the content 122. Results of the search are included in the content 220 displayed in the user interface 200. Similarly, a user may be able to sort the content using a sort module 204, which may sort by title, price, date, alphabetically, oldest to newest, newest to oldest, or other property. A display module 208 may be used to change how the content 220 is displayed. For example, by title, by issue, or the like. A filter module 210 may be used to filter the content 220 according to status. For example, the content 220 can be filtered by favorites, downloaded, or the like. The filter module 210 may also be able to filter according to format (e.g., replica, tablet).

A library button 216 may be used to identify content that has been placed in a library and may include downloaded content and/or non-downloaded content. A store button 214 may take a user to a store web page, where content or other merchandise can be purchased, subscriptions can be changed, or the like.

The user interface 200 may also have other features. For example, a bar 218 may be used to allow users to select certain categories of content. The bar 218 may identify certain categories that can be selected. As a result, the content 220 can be sorted in multiple layers using, by way of example only, the bar 218 and the filter module 210. In one example, the filter module 210 can be used to filter results in any category selected in the bar 218.

In one example, access to the content 122 can be governed according to various plans. In one example, access to the content 122 may be free for a set amount of time. The amount of time can be reflected in a timer 212 that may be presented in the user interface 200. The timer 212 reflects the amount of time left for free access to the content 122. Once the free time has expired, access to the content is disabled or prevented. The free time period may recur monthly in some examples. In the context of other plans, the timer 212 may be used to reflect how long a user has accessed the content 122. As described in more detail below, manipulation of the time can be regulated by including timing information in the token. The timing information may require that the time at the device be related to the device of the content server in a particular way, with certain allowances.

Another plan may permit unlimited access to content while the device is online for a fee or other consideration. In this plan, no offline access is permitted and the content is not downloaded, although the content may be downloaded for caching in some embodiments. Caching can improve performance. To the extent that the content is downloaded, the client 150 may prevent offline access to the content. Another plan includes unlimited access to the content 122 while online as well as offline access to the content 122. In order to provide offline access to the content 122, selected content may be downloaded. For example, the user may select specific resources that are then downloaded to the device. Downloaded content may expire in some examples. One of skill in the art, with the benefit of the present disclosure, can appreciate other plans for providing access to the content.

In some examples, access to the content can be controlled in various ways. The content can be password protected, include digital rights management techniques, or the like. In one example, access is governed using tokens. When determining whether a device is allowed access to the content 122, a token is used. In some embodiments, the token can expire, be updated, be replaced, or the like.

The token may be generated by the content server 110 or other token issuer. The token is then securely transmitted to the device 134 and can be used by the client 150. In one example, the parameters included in the token are serialized and a hash of the unencrypted value is made using a private key associated with the content server 110 or other token issuer. To prevent replay attacks, a one-time nonce may be used during encryption. The encrypted parameters and hash are transmitted to the client 150.

The transmission itself may occur over a secure connection. In one embodiment, however, the token can be transmitted over insecure connections/networks. A secure connection increases security, but is not required. The token is typically configured to be transmitted over insecure networks since it may be encrypted and may include other security factors, such as a nonce, to improve security.

The client 150 then validates the token. To validate the token, the client 150 may decrypt the serialized parameters using the public key corresponding to the private key and generate a hash of the decrypted parameters. When the newly computed hash matches the hash sent by the server, this process allows the token to be validated. This process of token generation also enables the token to be validated by either the content server 110 or the client 150 without having to connect to a central database or maintain any kind of state.

The parameters that are serialized in the token may include, but are not limited to, a unique device identification (e.g., a phone UUID, a hard disk ID), an expiration or expiry date of the parameters or of the token, features that are to be enabled or disabled, maximum duration that content can be viewed while the client 150 is not in contact with the content server 110 of offline, time (time of day) that the client 150 was last in contact with the content server 110, total page-views permitted, maximum total duration that any content can be viewed, or the like or any combination thereof.

The expiry date is typically set to a short amount of time after a date of renewal of a subscription (e.g., a grace period of 24 to 48 hours). For example, the token may expire each month when there is a monthly subscription. If the monthly subscription is not paid, the token is not renewed and access to the content is eventually disabled when the token becomes invalid. Alternatively, the token can be replaced with a different token allowing access to a free plan, which may allow timed access to the content.

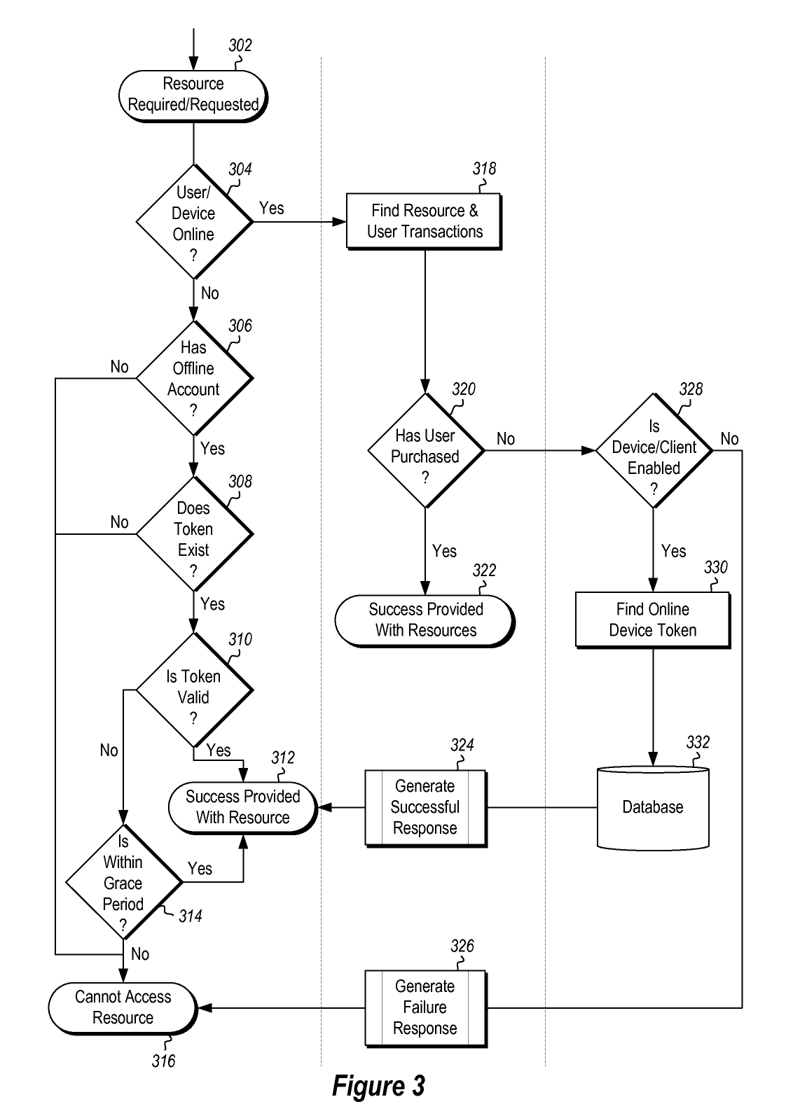

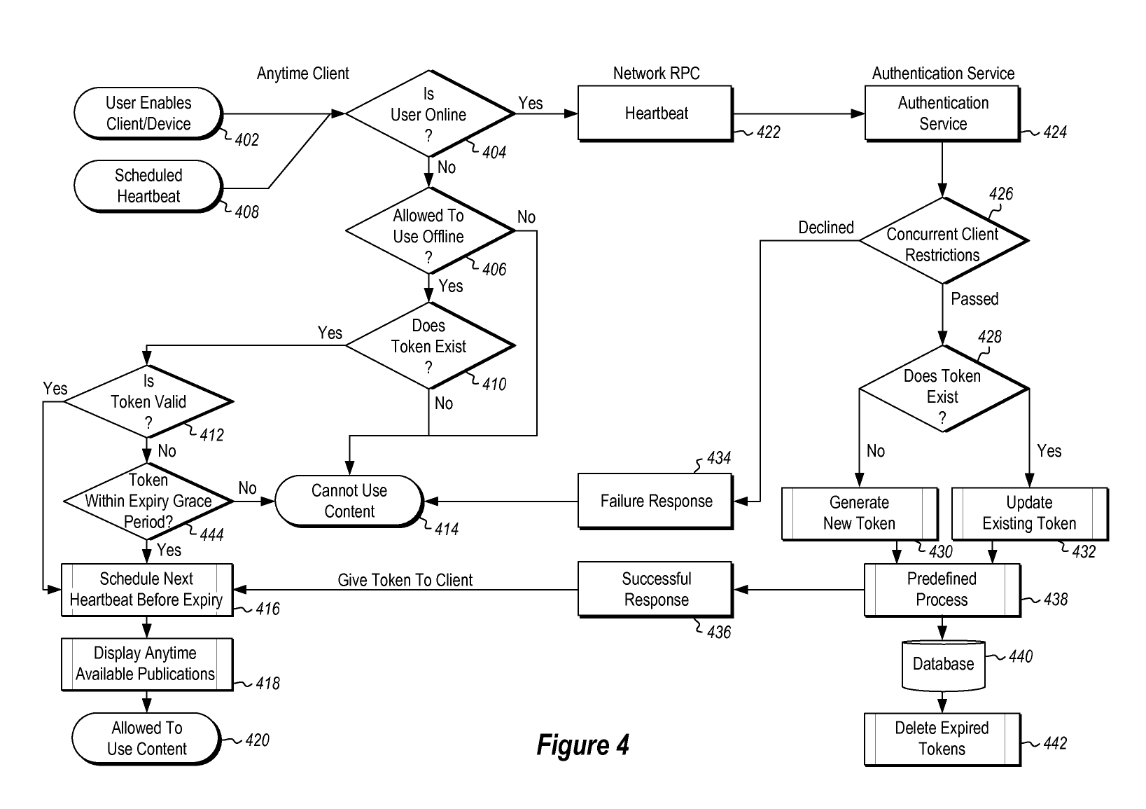

FIGS. 3 and 4 describe embodiments of the invention from the perspective of various devices in the network. Some aspects of the invention are described from the perspective of the device and/or client while other aspects are described from the perspective of the server. Although embodiments are described in the context of a content server, multiple servers may be used instead and certain responsibilities can be distributed among different servers. One of the servers, for example, may manage tokens, which includes token validation, token generation, maintaining and/or updating user/device data. Another server may operate to serve the content in response to user input at a device. Further, the elements of the methods are provided in detail and one of skill in the art can appreciate that some of the elements may be performed in a different order. In some embodiments, some of these elements may be omitted.

FIG. 3 illustrates an example of a flow diagram for allowing access to content. The method begins, for example, when the client 150 is executed and a resource is required or requested at 302. When the client 150 is first initiated, it may display a startup screen of content from a cache, for example. When the user begins to interact with the user interface 200, however, a resource may be requested. A resource may be an example of the content 122. A user may tap a resource displayed on a screen, for example, to request the resource associated with the displayed image.

At 304, a determination is made as to whether the device (or user) is online or if the device has network access. Online indicates that the device has a network connection and, in one example, is able to communicate with the content server 110. At 306, if the device or user is offline, a determination is made to determine if the user has an offline account or to determine if offline access is enabled. The ability to access content offline may be reflected in the parameters included in the token. An offline account allows the user to access content when the device is offline. If the user does not have an offline account, access is not granted to the resource or other content at 316. If the user has an offline account 306 and the client 150 determines that a token exists at 308 and that the token is valid at 310, then access to the resources is provided at 312. If the token is not valid at 310 and the token is within a grace period at 314, access is granted to the resource at 312 until the grace period expires. Otherwise if the token is not in the grace period at 314, access is denied at 316.

The validation of the token can be performed by the client 150 on the device 134. In one example, the validation can be performed without access to a central database and while offline. In this example, the device already has a token stored in memory of the device. The client can evaluate the token to determine if offline access is permitted. As previously described, the token includes parameters that can be used to make this determination. Offline access is one of the parameters in one example.

If, at 304, a user or device is determined to be online and able to contact the content server 110, the content server 110 may find the requested resource at 318 and identify any user transactions. The transactions may include prior purchases, plan identification, time remaining on a free plan, or the like. If the user or device is eligible (e.g., has time remaining or has purchased a plan) at 320, then access is granted at 322 to the content. If the user or device has purchased a plan at 320, then the device is provided with content at 322. The user transactions, for example, may indicate that a free time period is exhausted and may cause access to the content to be denied. Alternatively, the user or device may be able to access purchase content that may not be subject to the client. For instance, an issue of a magazine may be included in the content until it is replaced with a new issue. Thus, old issues, by way of example and not requirement, may not be included in the content 122, but may be available if purchased.

If the user has not purchased additional time or is not a subscriber at 320, a determination is made as to whether the client is enabled at 328. A client may be enabled, for example, when a user communicates with the content server to obtain an initial token. If the client is not enabled at 328, then a failure response is generated at 326 and access to the content is denied at 316. The user may be given an opportunity to enable the client. If the client is enabled at 328, then the token of the device is found at 320 or generated and delivered to the client, or uploaded to the content server. The token may be updated at this time and a database storing the device's token is updated at 332. Other data may also be updated at this time in one embodiment. A success response is generated at 324 and access to the content is enabled at 312.

The foregoing method illustrates that content can be accessed while offline in certain instances. FIG. 3 also illustrates that, when a device is online, communication may occur between the device and the content server. The communication is intended to update or replace the token, update information recorded at the device related to consumption of the content, determine whether access is still enabled, determine how much free time is left for a given device, or the like or any combination thereof.

FIG. 4 is an illustrative example of a flow diagram for accessing content. FIG. 4 is similar to FIG. 3 and further illustrates a heartbeat, which is an example of communication between the device and the content server. The heartbeat includes usage data in one example that is used to update data associated with the device and/or to update data associated with the consumption of content on the device. As a result of the heartbeat, the content server may also have information that is similar to the information stored at the device. The usage data can thus be used in the generation of or while updating tokens.

At 402, a user enables or initiates the client 150 and a heartbeat 408 is scheduled. The heartbeat can include usage data, as previously described, which may include the token assigned to the device. The token may be formulated based on information that is specific to a device. This prevents the token from being validated at another device in one example. If the user is online at 404, a heartbeat is sent at 422. An authentication service operating on the content server 110 receives the usage data or the token at 424 and evaluates restrictions on the client at 426. If the client is restricted (e.g., a failed payment), then a failure response is generated at 434 and access to the content is not allowed. If there are no restrictions, the existence of a token is determined at 428. If no token is present, a token is generated at 430. Alternatively, an existing token may be updated at 432. The token can be updated by updating the parameters that are included in the token.

Once the token is updated, the token may be processed 438 and stored in a database at 440 along with other usage data in one example. Expired tokens that may be stored in the database may be deleted at 442. Once the token is updated, a success response is generated at 436, the token is provided to the client and the next heartbeat is scheduled at 416. Access to the content is enabled at 418 and a user is allowed to access and consume the content at 420.

If the user is not online at 404, a determination is made as to whether offline access to the content is allowed at 406. If offline access is not allowed, the client and user are not allowed to have access to the content at 414. If offline access is permitted at 406 and a token exists at 410, the validity of the token is determined at 412. If the token is valid, the next heartbeat is scheduled at 416 at access to the content is enabled. If the token is not valid at 412 and the token is within an expiry grace period at 444, access to the content may be enabled. Otherwise, access is denied at 414.

In one embodiment, the client may not update the token (although a token could be updated for sharing purposes). The token issuer (e.g., content server) is usually responsible for updating the token or more generally, with delivering a new token to the device. Usually, security is maintained by only allowing the client to read the token. To validate a newly received token, in one embodiment, the client computes a hash of the token's parameters. Using the public key of the token issuer (which may be the content server in one example), the client decrypts the encrypted hash that is included in the token. The client hashes the parameters and ensures that the hashed token parameters match the decrypted hash value from the new token before allowing access to the content. These actions confirm that the token originated from an authorized issuer and that the token is secure and has not been tampered with.

The client may also check a device time against the token provider's time to ensure that no tampering has occurred between the supply of a previous token and the new token. In this case, allowance may be made for changes to the time (e.g., daylight savings time, time zone travelling). A constant time difference should be maintained (with allowances) between the device time and the token provider's time.

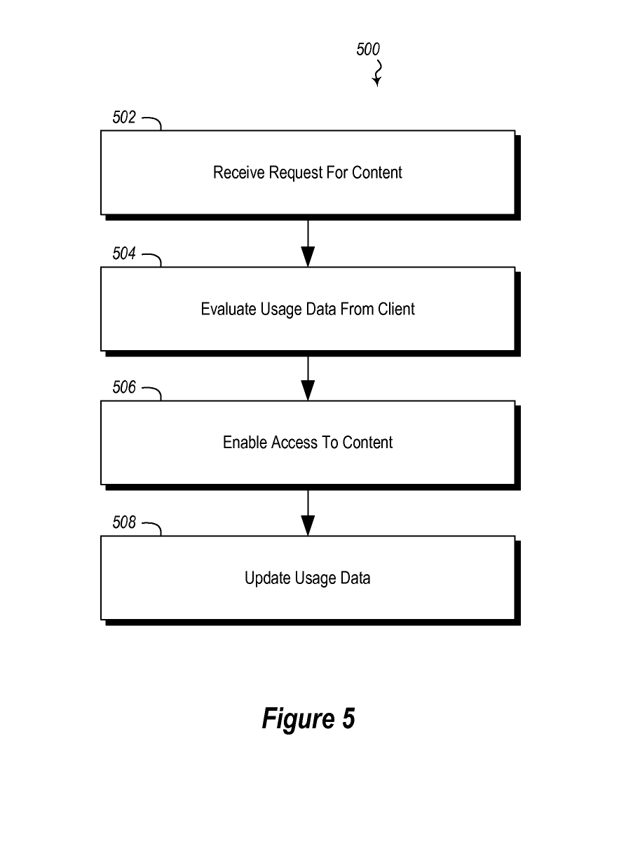

FIG. 5 illustrates a method for accessing content from the perspective of the content server. The method 500 begins when receiving a request for content from a device at block 502. The request is typically received when the client is online and is received by a content server. The request for content may include or be accompanied by a heartbeat that includes a token and/or usage data.

The usage data, which may include the token, is then evaluated by the content server at block 504. When evaluating the usage data, the content server may update the token (which may include generating a new token for the device) as well as the token database with the old token and/or the newly generated or updated token. The token database may be used to store tokens as well as the usage data associated with each device. For example, a user may be on a timed plan. The usage data may include the time that the user has used consuming content. If the time spent consuming content exceeds an allotted time or a predetermined amount, then the token is updated or replaced accordingly and access to the content is prevented by the new token. The content server can determine, based on the usage data and/or other rules, if a token should be generated and which parameters are included in the token. The token is then updated or generated and returned to the device, where it is used by the client to manage access to the data as discussed herein.

If a token is generated successfully based on the usage data, access to the content is enabled in block 506. This may include sending the token back to the client, which verifies and validates the token as previously described. The client can then access the content in accordance with the terms set forth in the token. The usage data is then updated in block 508 as previously described. The device may periodically send usage data to the content server. The usage data is used to update existing usage data, upon which future decisions regarding the token may be made as disclosed herein. The usage can also be updated independently of the token. For instance, a token may be valid for a month. During that month, however, usage data may be periodically sent to reflect and update the consumption of content.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

In an illustrative embodiment, any of the operations, processes, etc. described herein can be implemented as computer-readable instructions stored on a computer-readable medium. The computer-readable instructions can be executed by a processor of a mobile unit, a network element, a server computer (the content holder may be an example of a server computer) and/or any other computing device.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via various circuitries such as Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof. From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method for providing access to content, the method comprising:
receiving usage data from a device, the usage data including a token;
determining from the token whether the device is entitled to access content;
updating the token when the device is entitled to access the content; and
enabling access to the content.

2. The method of claim 1, further comprising assigning the updated token to the device.

3. The method of claim 1, further comprising transmitting the updated is token to the device, the updated token stored in memory of the device.

4. The method of claim 1, further comprising updating usage data associated with the device in a database.

5. The method of claim 1, further comprising receiving a request for content from the device.

6. The method of claim 1, further comprising transmitting content to the device for offline access.

7. A method for controlling access to content, the method comprising:
receiving a request to access a resource included in content from a user;
retrieving a token assigned to the user and stored in a device;
determining whether the token is valid at the device; and
allowing access to the resource when the token is determined to be valid.

8. The method of claim 1, further comprising sending usage data from the device to a content server, wherein the usage data includes the token.

9. The method of claim 7, further comprising determining whether the device is online or offline.

10. The method of claim 7, further comprising evaluating the token to determine if the device is entitled to access the resource offline when the device is offline.

11. The method of claim 8, further comprising sending the usage data for storage at a content server.

12. The method of claim 7, further comprising determining whether the token is valid by comparing an expiry date specified in the token with a current time, wherein the token is invalid if the current date is after the expiry date.

13. The method of claim 12, wherein the token is valid if the expiry date is within a grace period after the current date.

14. The method of claim 7, further comprising receiving an updated token from a content server.

15. A method for controlling access to content, the method comprising:
identifying a request from a user to access a resource;
retrieving a token assigned to the user, the token stored in a memory of the device;
determining whether the token is valid by evaluating one or more parameters included in the token; and
allowing access to the content when the token is valid.

16. The method of claim 15, further comprising determining whether the device is online or offline.

17. The method of claim 15, further comprising sending usage data, wherein the usage data reflects consumption of the resource or other content on the device.

18. The method of claim 15, further comprising receiving an updated token from a content server.

19. The method of claim 15, further comprising downloading content for offline usage based on the token.
